(19) United States
(12) Patent Application Publication
(10) Pub. No.: US 2010/0053329 A1
(43) Pub. Date: Mar. 4, 2010

(54) EXIT SECURITY

(76) Inventors: Myron D. Flickner, San Jose, CA (US); Arun Harnpapur, Norwalk, CT (US); Sharathchandra U. Pankanti, Norwalk, CT (US)

Correspondence Address: KEOHANE & D'ALESSANDRO PLLC;Intellectual Property Administration, Suite 180, 1881 Western Avenue, Albany, NY, 12203, US

(21) Appl. No.: 12/198,935

(22) Filed: Aug. 27, 2008

(51) Int. Cl. H04N 7/18; G08B 13/14

(52) U.S. Cl. 348/150; 340/568.1; 348/E07.085

(57) ABSTRACT

The present invention generally provides an exit security approach. Specifically, among other things, under the present invention: an item image for at least one of a set of items at a shopping checkout station is received; a receipt corresponding to the set of items is received; a first receptacle image of a shopping receptacle holding the set of items is received; a second receptacle image of the shopping receptacle is received; an integrity of the receipt is verified; the first receptacle image is compared to the second receptacle image; and it is determined whether a discrepancy exists based on at least one of the verification of the receipt and the comparison of the first receptacle image to the second receptacle image.

### CROSS-REFERENCE TO RELATED APPLICATIONS

This application is related in some aspects to the commonly owned and co-pending application entitled “Secure Self-Checkout,” filed Feb. 26, 2008, and which is assigned attorney docket number END920070216US1 and U.S. patent application Ser. No. 12/037,266, the entire contents of which are herein incorporated by reference. This application is related in some aspects to the commonly owned and co-pending application entitled “Smart Scanning System,” filed May 31, 2007, and which is assigned attorney docket number END920070210US1 and U.S. patent application Ser. Number 11/756,391, the entire contents of which are herein incorporated by reference. This application is related in some aspects to the commonly owned and co-pending application entitled “Portable Device-Based Shopping Checkout,” filed May 31, 2008, and which is assigned attorney docket number END920070211US1 and U.S. patent application Ser. No. 11/756,382, the entire contents of which are herein incorporated by reference. This application is related in some aspects to the commonly owned and co-pending application entitled “Item Scanning System,” filed Jul. 24, 2007, and which is assigned attorney docket number END920070222US1 and U.S. patent application Ser. No. 11/782,173, the entire contents of which are herein incorporated by reference.

### FIELD OF THE INVENTION

The present invention generally relates to self-checkout (e.g., retail). Specifically, the present invention provides a way to improve the security of self-checkout for increased loss prevention.

### BACKGROUND OF THE INVENTION

Shopping checkout (e.g., retail supermarket, etc.) is a process by which most everyone is familiar. Typical checkout involves a shopper navigating about a store collecting items/items for purchase. Often the shopper will utilize a shopping receptacle such as a shopping cart and/or shopping basket. Upon completion of gathering the desired items, the shopper will proceed to a checkout station for checkout (e.g., bagging and payment). In recent years, many stores have become equipped with self-checkout stations whereby a shopper will scan and bag the items his/herself, and then make payment via the self-checkout station.

It is desirable, when shoppers in supermarkets and other large retail stores self-check out, that the process be both as rapid as possible, to make the customer happy, and as secure as possible, to make the store happy. The more this process can be both instantaneous and 100% secure, the better. No existing process achieves these desired goals simultaneously. Self-checkout typically includes three separate functions that today are mostly lumped together at a single point of sale (POS) station: (1) enumerating each item to be purchased, and determining its price (typically, by presenting it to a bar code scanner), (2) verifying that each item is what it was claimed to be, and (3) paying for all the items. Unfortunately, with increased volumes of shoppers and instances of employee collusion, theft is growing at an alarming rate. Theft is made easier as stores implement shopper friendly conveniences such as self checkout as described above. As such there is currently no way to determine whether a shopper has switched price tags, scanned less all of the items in their cart/basket, added items to the cart/basket after checkout, etc. In view of the foregoing, there exists a need for a system that solves at least one of the above-referenced deficiencies in the related art.

### SUMMARY OF THE INVENTION

The present invention generally relates to exit security. Specifically, as a set (one or more) of items are scanned at a shopping checkout station, an item image of at least one of the item(s) will be taken and a receipt will be generated (e.g., after items are scanned and the transaction is completed). Under the present invention, individual “item” images can be captured. Such images can be captured for all item(s), or for only those items that have a price exceeding an adjustable, minimum value threshold. Either way, the item image allows it to be determined if an item has been mislabeled. That is, an identity of an item (as determined from a scan of its barcode) can be compared with its appearance (as determined from the item image) image for consistency. To this extent, the present invention could include a database that associates barcode identifiers with appearances/images. This database could be cross-referenced using either an identifier (e.g., corresponding to a barcode) or image.

Regardless, at the time of or after checking-out, a first “receptacle” image will be taken of the shopping receptacle (e.g., cart, basket, etc), and the path the receptacle follows will be tracked (e.g., from the checkout station to the exit). At or before the receptacle reaches an exit the exit, a second receptacle image thereof will be taken. At this time, the integrity of the receipt will be verified. Verification of the integrity of the receipt typically includes determining whether the receipt is an authentic/store-generated receipt or is a forged/altered receipt. In addition, before the shopper(s) leaves the store, it will be determined whether all items leaving the store have been scanned and paid for appropriately (i.e., properly accounted for). This can be accomplished in any number of ways such as: (a) determining whether the identity (as determined from the scanning of their barcodes) of the item(s) whose image(s) were captured is consistent with their appearance as determined by the image(s), (b) comparing the second receptacle image of the shopping receptacle to the first for any differences, (c) comparing of goods to the receipt (automatically using images of the goods as compared with the receipt and/or manual efforts). Based on the image comparison and/or receipt integrity verification, it will be determined whether a discrepancy exists. If so, an alarm can be generated.

A first aspect of the present invention provides an exit security method, comprising: receiving an item image for at least one of a set of items at a shopping checkout station; providing a receipt corresponding to the set of items; receiving a first receptacle image of a shopping receptacle holding the set of items; receiving a second receptacle image of the shopping receptacle; verifying an integrity of the receipt; comparing the first receptacle image to the second receptacle image; and determining whether a discrepancy exists based on at least one of the verifying or the comparing.

A second aspect of the present invention provides an exit security method, comprising: An exit security method, comprising: a module for receiving an item image for at least one of a set of items at a shopping checkout station; a module for providing a receipt corresponding to the set of items; a module for receiving a first receptacle image of a shopping receptacle holding the set of items; a module for receiving a second receptacle image of the shopping receptacle; a module for verifying an integrity of the receipt; a module for comparing the first receptacle image to the second receptacle image; and a module for determining whether a discrepancy exists based on at least one of the verification of the receipt and the comparison of the first receptacle image to the second receptacle image.

A third aspect of the present invention provides at least one computer readable medium containing at least one program product for providing shopping exit security, the at least one computer readable medium comprising program code for causing at least one computer system to: receive an item image for at least one of a set of items at a shopping checkout station; provide a receipt corresponding to the set of items; receive a first receptacle image of a shopping receptacle holding the set of items; receive a second receptacle image of the shopping receptacle; verify an integrity of the receipt; compare the first receptacle image to the second receptacle image; and determine whether a discrepancy exists based on at least one of the verification of the receipt and the comparison of the first receptacle image to the second receptacle image.

A fourth aspect of the present invention provides a method for deploying a system for shopping exit security comprising: deploying a computer infrastructure being operable to: receive an item image for at least one of a set of items at a shopping checkout station; provide a receipt corresponding to the set of items; receive a first receptacle image of a shopping receptacle holding the set of items; receive a second receptacle image of the shopping receptacle; verifying an integrity of the receipt; compare the first receptacle image to the second receptacle image; and determine whether a discrepancy exists based on at least one of the verification of the receipt and the comparison of the first receptacle image to the second receptacle image.

A fifth aspect of the invention provides at least one data processing system for providing exit security, comprising: at least one memory medium having instructions; at least one bus coupled to the memory medium; and at least one processor coupled to the least one bus that when executing the instructions causes the at least one data processing system to: receive an item image for at least one of a set of items at a shopping checkout station; provide a receipt corresponding to the set of items; receive a first receptacle image of a shopping receptacle holding the set of items; receive a second receptacle image of the shopping receptacle; verify an integrity of the receipt; comparing the first receptacle image to the second receptacle image; and determine whether a discrepancy exists based on at least one of the verification of the receipt and the comparison of the first receptacle image to the second receptacle image.

A sixth aspect of the invention provides a computer-implemented business method for providing exit security, comprising: receiving an item image for at least one of a set of items at a shopping checkout station; providing a receipt corresponding to the set of items; receiving a first receptacle image of a shopping receptacle holding the set of items; receiving a second receptacle image of the shopping receptacle; verifying an integrity of the receipt; comparing the first receptacle image to the second receptacle image; and determining whether a discrepancy exists based on at least one of the verification of the receipt and the comparison of the first receptacle image to the second receptacle image.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a checkout station with various shopping receptacles according to an embodiment of the present invention.

FIG. 2 show an image capture processing operation according to the present invention.

FIG. 3 depicts integrated image capture and scanning system according to the present invention.

FIG. 4 depicts a hand-held scanner implementation according to the present invention.

FIG. 5 depicts an exit station according to the present invention.

FIG. 6 depicts a more specific computerized implementation according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following Sections:

I. General Description

II. Computerized Implementation

### I. General Description

As used herein, the following terms have the associated meanings:

“Set”—a quantity of at least one.

“Shopping Receptacle”—any container capable of holding items such as a shopping cart, a shopping basked, a shopping bag, etc.

“Image Capture Device”—means any type of camera or the like such as a still image camera, a video camera, etc.

As indicated above, the present invention generally relates to exit security. Specifically, as a set of items are scanned at a shopping checkout station, an item image of at least one of the item(s) will be taken and a receipt will be generated (e.g., after items are scanned and the transaction is completed). Under the present invention, individual “item” images can be captured. Such images can be captured for all item(s), or for only those items that have a price exceeding an adjustable, minimum value threshold. Either way, the item image allows it to be determined if an item has been mislabeled. That is, an identity of an item (as determined from a scan of its barcode) can be compared with its appearance (as determined from the item image) image for consistency. To this extent, the present invention could include a database that associates barcode identifiers with appearances/images. This database could be cross-referenced using either an identifier (e.g., corresponding to a barcode) or image.

Regardless, at the time of or after checking-out, a first “receptacle” image will be taken of the shopping receptacle (e.g., cart, basket, etc), and the path the receptacle follows will be tracked (e.g., from the checkout station to the exit). At or before the receptacle reaches an exit the exit, a second receptacle image thereof will be taken. At this time, the integrity of the receipt will be verified. Verification of the integrity of the receipt typically includes determining whether the receipt is an authentic/store-generated receipt or is a forged/altered receipt. In addition, before the shopper(s) leaves the store, it will be determined whether all items leaving the store have been scanned and paid for appropriately (i.e., properly accounted for). This can be accomplished in any number of ways such as: (a) determining whether the identity (as determined from the scanning of their barcodes) of the item(s) whose image(s) were captured is consistent with their appearance as determined by the image(s), (b) comparing the second receptacle image of the shopping receptacle to the first for any differences, (c) comparing of goods to the receipt (automatically using images of the goods as compared with the receipt and/or manual efforts). Based on the image comparison and/or receipt integrity verification, it will be determined whether a discrepancy exists. If so, an alarm can be generated.

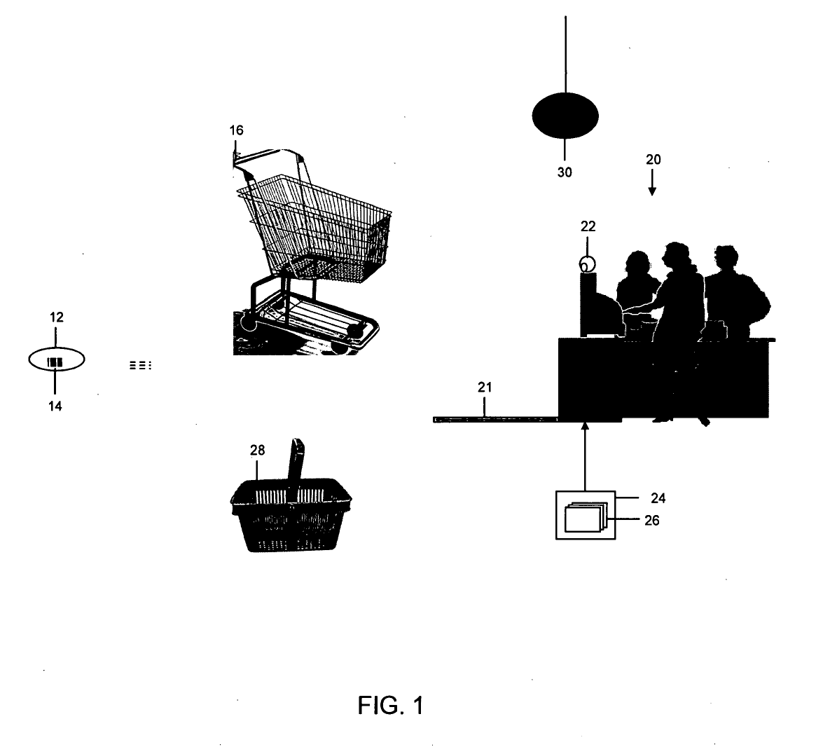

These concepts will now be explained in greater detail with respect to FIGS. 1-4. Specifically, FIG. 1 shows various shopping receptacles 16 and 28. Regardless of the type of shopping receptacle used, a scan of a barcode 14 of an item 12 (e.g., a consumer product) will be received using handheld scanner 14. Based on the barcode 14, modules 26 of secure checkout system system/program 24 will determine an identity of item 12. This occurs via known methodology such as cross-referencing a table of barcode values to product identities.

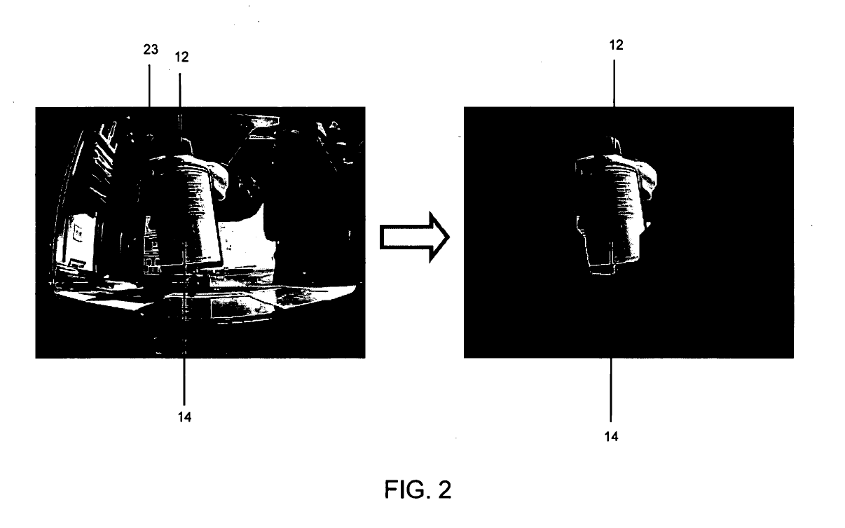

Before, after or simultaneous to the scan of the barcode, an image (23 in FIG. 2) of item 12 will be captured by image capture device 22, and processed to determine an appearance of the item 12 (which should be consistent with the identity as determined based on the scan of barcode 14). The sequence of capturing and processing the image is shown in FIG. 2 and typically occurs as follows: wait for low motion of item 12; take dark and bright pictures; segment item 12 from background 20; extract at least one visual feature of item 12 and determine the identity based on those visual features.

Regardless, modules 26 of exit security program 24 will determine whether the appearance of item 12 is consistent with its identification. This determination can be based on a comparison of the image to an electronic database or library of images associated with corresponding item identities. In addition, the appearance can be as general or as specific as desired. For example, the appearance can be specific so as to identify the item (e.g., a bottle of X brand cola), or it can be more general (e.g., a bottle of cola, or just cola based on the color). If not, the secure checkout system will register a discrepancy and provide a notification of the discrepancy (at least one of a visual notification or an audible notification). Where there is a discrepancy, the secure checkout system will then determine whether the discrepancy is either error or fraud. For example, whether the barcode tampered with or changed, or whether the discrepancy due to device error. Where device error caused the discrepancy, the secure checkout system can be updated (e.g., in response to an operator's input) to reflect the true identity of the item and its association with the image just captured. Regardless, the scan, the image, and a shopping event to which they correspond/pertain can then be stored for post investigation.

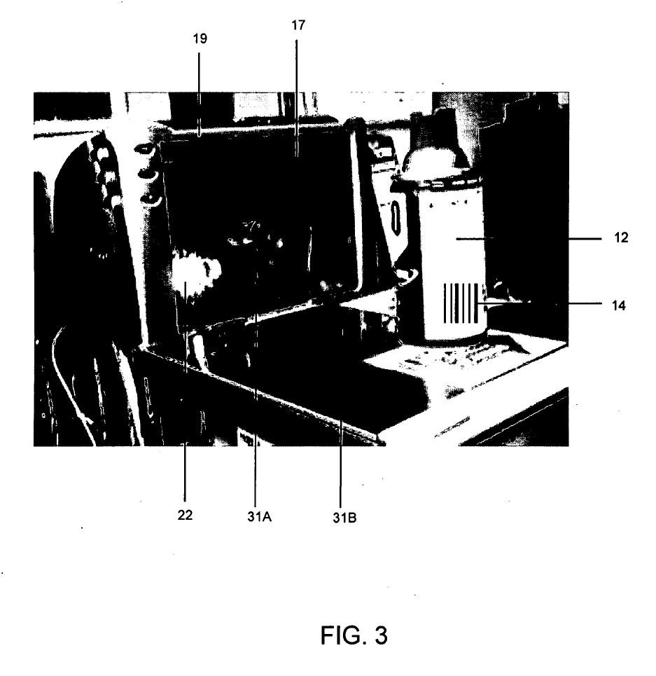

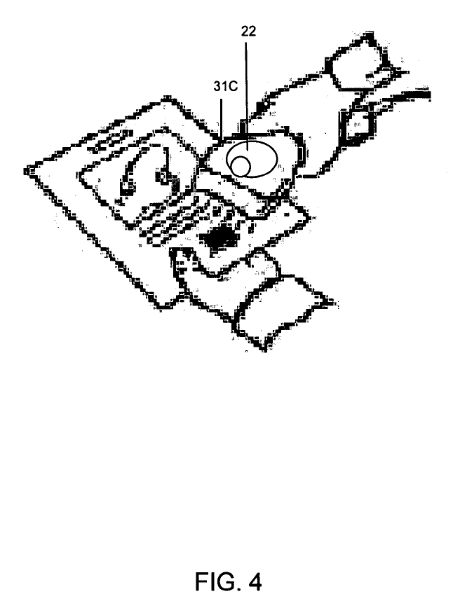

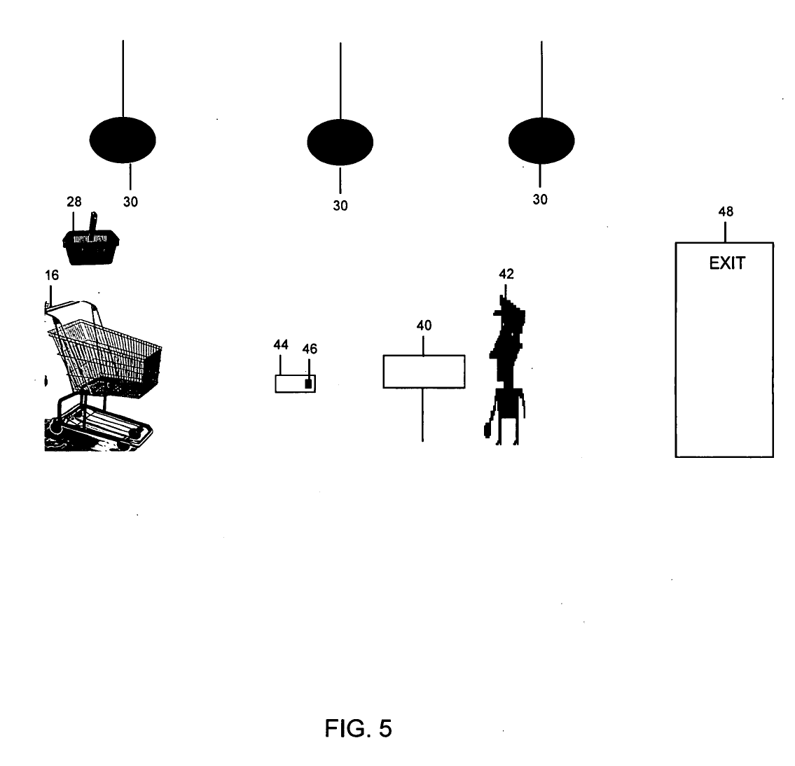

As shown in FIG. 1, image capture device 22 is mounted on checkout station 20. However, it should be understood that many variations could be implemented, such as mounting image capture device on shopping receptacles 16 and 28, above checkout station 30, etc. Still yet, image capture device could be mounted within an integrated image capture and scanning system 19. In the example shown in FIG. 3, image capture device 22 is mounted within a housing 17 with scanner 31A (scanner 31B is outside of the housing). As shown in FIG. 4, image capture device 22 should be located on a hand-held scanner 31C. It should be noted that all features herein could be applied to a self-checkout station as well as a personnel-based checkout station. Under the present invention, images can be captured for every item, or for only those items whose price exceeds a minimum value threshold (e.g., big ticket items), Regardless, a receipt 44 (FIG. 5) will be generated with a unique, machine-readable identifier 46 (FIG. 5) pursuant to checkout.

At any point in the process (although typically before the user removes items from their shopping receptacle for scanning), a first “receptacle” image will be captured of the shopping receptacle and its contents. As will be further described below, first receptacle image will be used to determine whether all items leaving the store have been paid for (or were free, promotional, etc). After check-out, as the user moves about the store (e.g., to an exit), the shopping receptacle will be tracked (e.g., via cameras 30). This helps to detect whether the user inserted any more items into the shopping receptacle.

As mentioned above, before the user exits the store (such as at exit 48), two determinations will be made: (1) that the receipt is authentic and has not been tampered with; and (2) that all items leaving the store are authorized to leave the store (e.g., been paid for, or were free). The former can be performed using the unique, machine readable identifier 46 on receipt 44 using kiosk 40 and/or personnel 42. Specifically, unique, machine readable identifier 46 will be checked against a log or the like of valid identifiers to ensure it is authentic and has not been tampered with. In addition, another “receptacle” image will be captured. This “receptacle” image will be compared against previous “receptacles” image(s) for any discrepancy (e.g., if items have been added to the shopping receptacle since check-out. If the receipt is not verified and/or there is an image discrepancy, an alarm could be generated (silent or audible). It should be understood that all processing can occur via a single system (exit security system 24 of FIG. 1, or via multiple separate systems that work in concert.

It should be understood that scale 21 (shown in FIG. 1) that weighs a shopping receptacle and/or items, can be used to determine whether all items have been accounted for. One way to do this is to determine if a weight of a receptacle, and/or item(s) is consistent with their identity as determined for the barcode. This is especially helpful to determine if product labels have been switched.

### II. Computerized Implementation

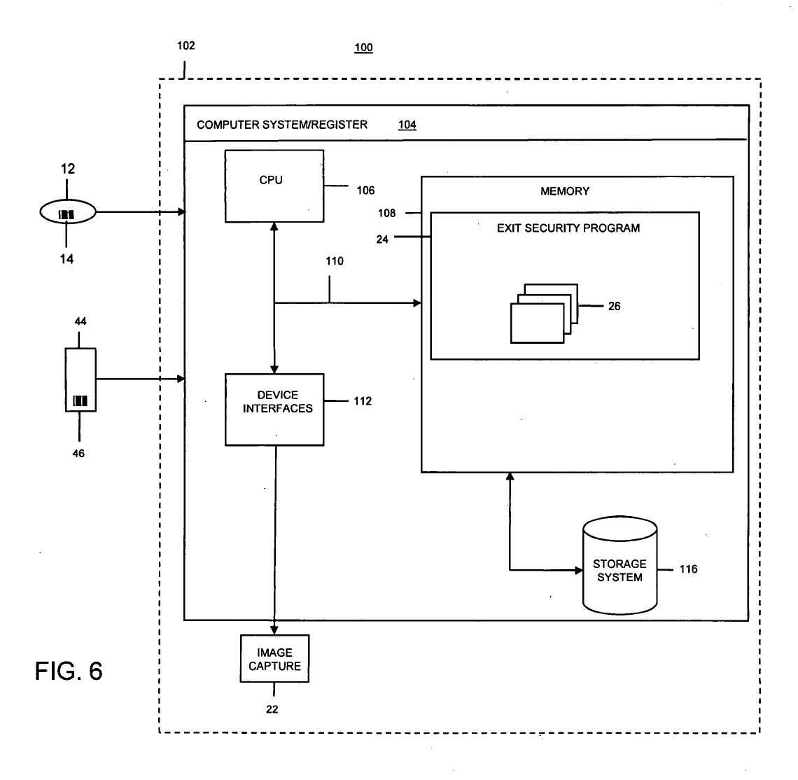

Referring now to FIG. 6, a computerized implementation 100 of the present invention is shown. As depicted, implementation 100 includes computer system/register 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc. by a service provider who offers to implement, deploy, and/or perform the functions of the present invention for others.

As shown, computer system/register 104 includes a processing unit 106, a memory 108, a bus 110, and device interfaces 112. Further, computer system/register 104 is shown communicating with one or more external devices such as image capture devices 22 and or 30 that communicate with bus via device interfaces (although image capture device 22 could be integrated such as shown in 3). In general, processing unit 106 executes computer program code, such as reward software/program 24, which is stored in memory 108 and/or storage system 116. While executing computer program code, processing unit 106 can read and/or write data to/from memory 108, storage system 116, and/or device interfaces 112. Bus 110 provides a communication link between each of the components in computer system/register 104. Although not shown, computer system/register 104 could also include I/O interfaces that communicate with: one or more external devices such as a kiosk, a checkout station, a keyboard, a pointing device, a display, etc.); one or more devices that enable a user to interact with computer system/register 104; and/or any devices (e.g., network card, modem, etc.) that enable computer system/register 104 to communicate with one or more other computing devices.

Computer infrastructure 102 is only illustrative of various types of computer infrastructures for implementing the invention. For example, in one embodiment, computer infrastructure 102 comprises two or more computing devices (e.g., a server cluster) that communicate over a network to perform the various process of the invention. Moreover, computer system/register 104 is only representative of various possible computer systems that can include numerous combinations of hardware. To this extent, in other embodiments, computer system/register 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, device interfaces 112 can comprise any module for exchanging information with one or more external devices. Still further, it is understood that one or more additional components (e.g., system software, math co-processing unit, etc.) not shown in FIG. 2 can be included in computer system/register 104.

Storage system 116 can be any type of system capable of providing storage for information under the present invention. To this extent, storage system 116 could include one or more storage devices, such as a magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system/register 104.

Shown in memory 108 of computer system/register 104 is exit security program 24, which a set of modules 26. The modules generally provide the functions of the present invention as described herein. Specifically (among other things), set of modules 26 is configured to: receiving an item image for at least one of set of items at a shopping checkout station; providing a receipt corresponding to the set of items; receiving a first receptacle image of a shopping receptacle holding the set of items; receiving a second receptacle image of the shopping receptacle; verifying an integrity of the receipt; comparing the first receptacle image to the second receptacle image; determining whether a discrepancy exists based on at least one of the verifying or the comparing; raising an alarm if the discrepancy exists; receiving a scan of a barcode for each of the set of items; determining an identity of each of the set of items from the barcode; determining whether the identity of the at least one of the set of items is consistent with an appearance of the at least one of the set of items, the appearance of the at least one of the set of items being based on the item image; and tracking the shopping receptacle from the shopping checkout station to the exit.

While shown and described herein as a customer reward solution, it is understood that the invention further provides various alternative embodiments. For example, in one embodiment, the invention provides a computer-readable/useable medium that includes computer program code to enable a computer infrastructure to provide customer rewards. To this extent, the computer-readable/useable medium includes program code that implements each of the various process of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 6) and/or storage system 116 (FIG. 6) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to provide customer rewards. In this case, the service provider can create, maintain, support, etc., a computer infrastructure, such as computer infrastructure 102 (FIG. 6) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for customer rewards. In this case, a computer infrastructure, such as computer infrastructure 102 (FIG. 6), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system/register 104 (FIG. 6), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic device system/driver for a particular computing and/or device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or device devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. An exit security method, comprising:
receiving an item image for at least one of a set of items at a shopping checkout station;
providing a receipt corresponding to the set of items;
receiving a first receptacle image of a shopping receptacle holding the set of items;
receiving a second receptacle image of the shopping receptacle;
verifying an integrity of the receipt;
comparing the first receptacle image to the second receptacle image; and
determining whether a discrepancy exists based on at least one of the verifying and the comparing.

2. The exit security method of claim 1, further comprising raising an alarm if the discrepancy exists.

3. The exit security method of claim 1, the first receptacle image being captured at the checkout station, and the second receptacle image being captured away from the checkout station.

4. The exit security method of claim 1, further comprising:
receiving a scan of a barcode for each of the set of items;
determining an identity of each of the set of items from the barcode; and
the verifying comprising determining whether the identity of the at least one of the set of items is consistent with an appearance of the at least one of the set of items, the appearance of the at least one of the set of items being based on the item image.

5. The exit security method of claim 1, the receipt having a timestamp encoded, unique machine readable identifier, and the verifying being based on the timestamp encoded, unique machine readable identifier.

6. The exit security method of claim 1, the at least one of the set of items each having a value above a minimum value threshold, the minimum value threshold being adjustable.

7. The exit security method of claim 1, further comprising tracking the shopping receptacle from the shopping checkout station to the exit.

8. An exit security system, comprising:
a module for receiving an item image for at least one of a set of items at a shopping checkout station;
a module for providing a receipt corresponding to the set of items;
a module for receiving a first receptacle image of a shopping receptacle holding the set of items;
a module for receiving a second receptacle image of the shopping receptacle;
a module for verifying an integrity of the receipt;
a module for comparing the first receptacle image to the second receptacle image; and
a module for determining whether a discrepancy exists based on at least one of the verification of the receipt and the comparison of the first receptacle image to the second receptacle image.

9. The exit security system of claim 8, further comprising a module for raising an alarm if the discrepancy exists.

10. The exit security system of claim 8, further comprising:
a module for receiving a scan of a barcode for each of the set of items;
a module for determining an identity of each of the set of items from the barcode; and
the module for verifying being configured to determine whether the identity of the at least one of the set of items is consistent with an appearance of the at least one of the set of items, the appearance of the at least one of the set of items being based on the item image.

11. The exit security method of claim 8, the receipt having a timestamp encoded, unique machine readable identifier, and the module for verifying being configured to verify the integrity of the receipt based on the timestamp encoded, unique machine readable identifier.

12. The exit security system of claim 8, the set of items each having a value above a minimum value threshold, the minimum value threshold being adjustable.

13. The exit security system of claim 8, further comprising a module for tracking the shopping receptacle from the shopping checkout station to the exit.

14. At least one computer readable medium containing at least one program product for providing shopping exit security, the at least one computer readable medium comprising program code for causing at least one computer system to:
receive an item image for at least one of a set of items at a shopping checkout station;
provide a receipt corresponding to the set of items;
receive a first receptacle image of a shopping receptacle holding the set of items;
receive a second receptacle image of the shopping receptacle;
verify an integrity of the receipt;
compare the first receptacle image to the second receptacle image; and
determine whether a discrepancy exists based on at least one of the verification of the receipt and the comparison of the first receptacle image to the second receptacle image.

15. The at least one computer readable medium containing the at least one program product of claim 14, the at least one computer readable medium further comprising program code for causing the at least one computer system to raise an alarm if the discrepancy exists.

16. The at least one computer readable medium containing the at least one program product of claim 14, the at least one computer readable medium further comprising program code for causing the at least one computer system to:
receive a scan of a barcode for each of the set of items;
determine an identity of each of the set of items from the barcode; and
determine whether the identity of the at least one of the set of items is consistent with an appearance of the at least one of the set of items, the appearance of the at least one of the set of items being based on the item image.

17. The at least one computer readable medium containing the at least one program product of claim 14, the receipt having a timestamp encoded, unique machine readable identifier, and the at least one computer readable medium further comprising program code for causing the at least one computer system to verify the integrity of the receipt based on the timestamp encoded, unique machine readable identifier.

18. The at least one computer readable medium containing the at least one program product of claim 14, the set of items each having a value above a minimum value threshold, the minimum value threshold being adjustable.

19. The at least one computer readable medium containing the at least one program product of claim 14, the at least one computer readable medium further comprising program code for tracking the shopping receptacle from the shopping checkout station to the exit.

20. A method for deploying a system for shopping exit security comprising:
deploying a computer infrastructure being operable to:
receive an item image for at least one of a set of items at a shopping checkout station;
provide a receipt corresponding to the set of items;
receive a first receptacle image of a shopping receptacle holding the set of items;
receive a second receptacle image of the shopping receptacle;
verify an integrity of the receipt;
compare the first receptacle image to the second receptacle image; and
determine whether a discrepancy exists based on at least one of the verification of the receipt and the comparison of the first receptacle image to the second receptacle image.
